(19) United States
(12) Patent Application Publication
(10) Pub. No.: US 2024/0253640 A1
(43) Pub. Date: Aug. 1, 2024

(54) ARCHTECTURE AND EXECUTION OF TORQUE COORDINATION FOR ELECTRIC VEHICLE TRANSMISSION SHIFT CONTROLS

(71) Applicant: GM Global Technology Operations LLC, Detroit, MI (US)

(72) Inventors: Dongxu Li, Troy, MI (US); Su-Yang Shieh, Clawson, MI (US); Chunhao J. Lee, Troy, MI (US); Paul Guillermo Otanez, Franklin, MI (US); Jason C. Jousma, Holly, MI (US); Matthew Pruski, Brighton, MI (US)

(21) Appl. No.: 18/163,141

(22) Filed: Feb. 1, 2023

(51) Int. Cl. B60W 30/188; B60W 10/08; B60W 10/11; B60W 30/20

(52) U.S. Cl. CPC B60W 30/188; B60W 10/08; B60W 10/11; B60W 30/20; B60W 2510/1005; B60W 2510/1025; B60W 2710/083

(57) ABSTRACT

A vehicle includes a control system that performs method of operating the vehicle. The control system includes a first motor processor associated with a first motor of the vehicle. The first motor processor receives a torque command from a vehicle motion control module, coordinates an allocation of the torque command into a first motor torque at the first motor and a transmission torque at a first transmission associated with the first motor, and controls the first motor to apply the torque command at the first motor.

### INTRODUCTION

The subject disclosure relates to operation of transmissions in electric vehicles and, in particular, to a method and system for coordinating torque allocation between motors and transmission of an electric vehicle.

Electric vehicles use electric motors to provide a torque to an axle of a vehicle in order to cause the vehicle to move. The electric vehicle can have a front motor at a front axle and a rear motor at a second axle. Torque requirements can be different for each axle. In addition, at a given axle, torque can be provided by many parts along a driveline of the axle, including the motor and the transmission. Controlling an output of the torque at the axle, and hence a speed of the vehicle, can thus require coordination of various elements of the driveline. Accordingly, it is desirable to provide a system and method for controlling torque elements to satisfy torque requirements for the vehicle.

### SUMMARY

In one exemplary embodiment, a method of operating a vehicle is disclosed. A torque command is received from a vehicle motion control module at a first motor processor associated with a first motor of the vehicle. An allocation is coordinated at the first motor processor of the torque command into a first motor torque at the first motor and a transmission torque at a first transmission associated with the first motor. The first motor is controlled to apply the first motor torque at the first motor.

In addition to one or more of the features described herein, the method further includes receiving a transmission control module request from the first transmission and controlling the first motor to fulfill the transmission control module request. The further includes receiving, at the first motor processor, at least one of the transmission control module request, a current gear state, and a current shift operation of the first transmission. The method further includes determining, at the first motor processor, an amount of torque assistance from a second motor and sending a torque assistance request to a second motor processor associated with the second motor. The second motor processor adjusts a second torque at the second motor in response to receipt of the torque assistance request. The method further includes sending the torque assistance request when at least one of the first motor is unable to fulfill a transmission control module request and the first torque at the first motor is equal to or greater than a torque limit for the first motor. The method further includes controlling the first motor to apply the first motor torque to fulfill one of a driver's request, a speed control, an active damping at the vehicle, and a transmission control module request.

In another exemplary embodiment, a control system for operating a vehicle is disclosed. The control system includes a first motor processor associated with a first motor of the vehicle. The first motor processor is configured to determine a torque command, coordinate an allocation of the torque command into a first motor torque at the first motor and a transmission torque at a first transmission associated with the first motor, and control the first motor to apply the torque command at the first motor.

In addition to one or more of the features described herein, the control system further includes a transmission control module at the first transmission, wherein the first motor processor is further configured to receive a transmission control module request from the transmission control module and control the first motor to fulfill the transmission control module request. The first motor processor is further configured to receive at least one of the transmission control module request, a current gear state, and a current shift operation of the first transmission. The control system further includes a second motor processor at a second motor of the vehicle, wherein the first motor processor is further configured to determine an amount of torque assistance from the second motor and sending a torque assistance request to the second motor processor associated with the second motor. The second motor processor is configured to adjust a second torque at the second motor in response to receipt of the torque assistance request. The first motor processor is further configured to send the torque assistance request when at least one of the first motor is unable to fulfill a transmission control module request and the first torque at the first motor is equal to or greater than a torque limit for the first motor. The first motor processor is further configured apply the first motor torque to fulfill at least one of: a driver's request, a speed control, active damping at the vehicle, and a transmission control module request.

In yet another exemplary embodiment, a vehicle is disclosed. The vehicle includes a first motor processor associated with a first motor of the vehicle. The first motor processor is configured to determine a torque command, coordinate an allocation of the torque command into a motor torque at the first motor and a transmission torque at a first transmission associated with the first motor, and control the first motor to apply the torque command at the first motor.

In addition to one or more of the features described herein, the vehicle further includes a transmission control module associated with the first transmission, wherein the first motor processor is further configured to receive a transmission control module request from the transmission control module and to control the first motor to fulfill the transmission control module request. The first motor processor is further configured to receive at least one of the transmission control module request, a current gear state, and a current shift operation of the first transmission. The vehicle further includes a second motor processor at a second motor, wherein the first motor processor is further configured to determine an amount of torque assistance from the second motor and send a torque assistance request to the second motor processor associated with the second motor. The second motor processor is configured to adjust a second torque at the second motor in response to receipt of the torque assistance request. The first motor processor is further configured to send the torque assistance request when at least one of the first motor is unable to fulfill a transmission control module request and the first torque at the first motor is equal to or greater than a torque limit for the first motor.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 shows a schematic diagram of an electric vehicle in a plan view, in accordance with an exemplary embodiment;

FIG. 2 is a diagram showing a flow of logic through elements of the control system to perform torque coordination at the motors of the electric vehicle;

FIG. 3 shows a priority sequence for torque arbitration through a single motor;

FIG. 4 schematically shows a feedback operation in the control system; and

FIG. 5 shows a graph of various parameters of the control system, in an illustrative embodiment.

### DETAILED DESCRIPTION

The following description is merely exemplary in nature and is not intended to limit the present disclosure, its application or uses. It should be understood that throughout the drawings, corresponding reference numerals indicate like or corresponding parts and features. As used herein, the term module refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

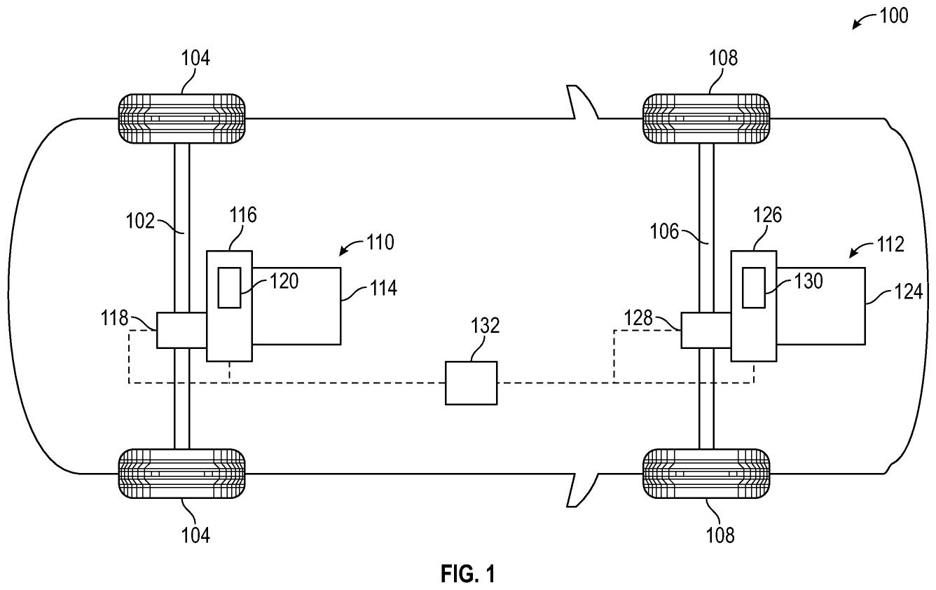

In accordance with an exemplary embodiment, FIG. 1 shows a schematic diagram of an electric vehicle 100 in a plan view. In other embodiments, the vehicle can be any type of vehicle, including a non-electric vehicle. The electric vehicle 100 (or battery electric vehicle) includes a first axle (rear axle 102) that connects rear tires 104 and a second axle (front axle 106) that connects front tires 108. A first drive system 110 provides power to the rear axle 102, and a second drive system 112 provides power to the front axle 106. The first drive system 110 can include a first battery (rear battery 114), first motor (rear motor 116), and first transmission (rear transmission 118). The rear motor 116 is an electric motor that converts power from the rear battery 114 into kinetic energy in the form of a rotation. The rear transmission 118 engages the rear motor 116 to transfer the rotation from the rear motor to the rear axle 102 and rear tires 104. Torque can be transferred to the rear axle 102 via the rear motor 116 and the rear transmission 118. The rear motor 116 can include a first regenerative braking system 120. During braking, the first regenerative braking system 120 converts a rotational energy of the rear axle 102 into electrical energy or current which is used recharge the rear battery 114.

Similarly, the second drive system 112 can include a second battery (front battery 124), second motor (front motor 126), and second transmission (front transmission 128). The front motor 126 is an electric motor that converts power from the front battery 124 into kinetic energy in the form of a rotation. The front transmission 128 can engage the front motor 126 to transfer the rotation to the front axle 106 and front tires 108. Torque can be transferred to the front axle 106 via the front motor 126 and the front transmission 128. The front motor 126 can include a second regenerative braking system 130. During braking, the second regenerative braking system 130 converts a rotational energy of the front axle 106 into electrical energy or current which is used recharge the front battery 124. In an embodiment, the second drive system 112 can be engaged when the electric vehicle 100 is placed in an all-wheel drive mode and can be disengaged or shut down when not in the all-wheel drive mode.

While the electric vehicle 100 of FIG. 1 shows two drive systems, it is understood that there can be additional drive systems for different embodiments of the vehicle. In various applications, the rear axle can have multiple drive systems and/or the front axle can have multiple drive systems. Additionally, it is understood that the rear battery 114 and the front battery 124 can be replaced by a single battery that powers both the rear motor 116 and the front motor 126.

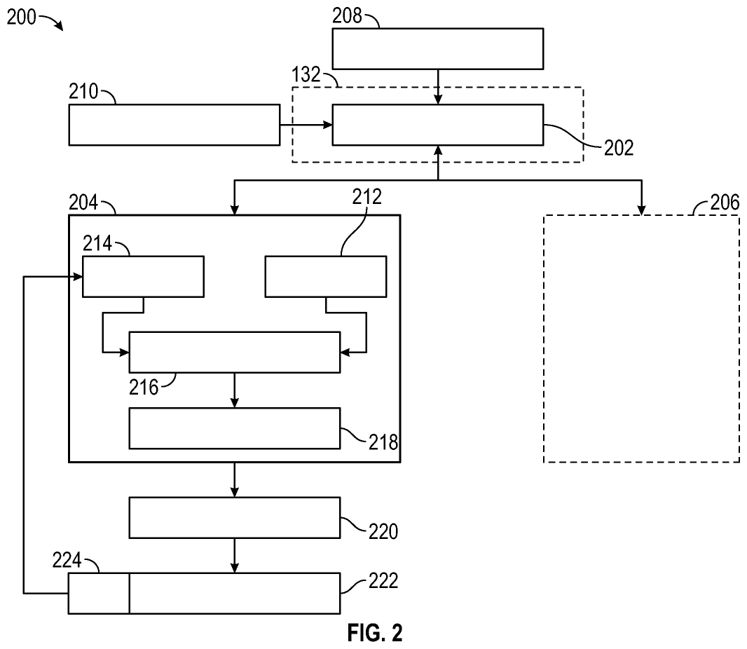

A controller performs various operations of the vehicle, as discussed herein. As shown in FIG. 1, the controller can be a main controller 132 that is a standalone component of the electric vehicle 100. Alternatively, the controller can be motor controller integrated into one of the motors, such as a first motor processor 204 (FIG. 2) or a second motor processor 206 (FIG. 2). The controller can obtain measurements of the drive system(s) to determine operational parameters of the drive system(s) including output torque and efficiency. The controller can also send torque commands to the rear motor 116 and the front motor 126 based on the measurements. The controller may include processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality. The controller may also include a non-transitory computer-readable medium that stores instructions which are processed by one or more processors of the controller to implement processes detailed herein. Additional processors disclosed herein also execute one or more software or firmware programs, a combinational logic circuit, and/or other suitable components that provide the described functionality and include a non-transitory computer-readable medium that stores instructions which are processed by one or more processors of the controller to implement processes detailed herein.

FIG. 2 is a diagram showing a flow of logic through elements of the control system 200 to perform torque coordination at the motors of the electric vehicle 100. Although shown with respect to the physical hardware of the control system 200, the flow diagram can be understood as operating separate from the physical hardware. The control system 200 includes a vehicle motion control module 202, a first motor processor 204 that is a component of the first motor (e.g., rear motor 116) and a second motor processor 206 that is a component of the second motor (e.g., front motor 126). The vehicle motion control module 202 can be located at the main controller 132, at the first motor processor 204 or at the second motor processor 206. Alternatively, some or all of the main controller 132, first motor processor 204 and second motor processor 206 can have individual vehicle motion control modules. For purposes of explanation, the main controller 132 can include a main vehicle motion control module, the first motor processor 204 can include a first vehicle motion control module, and the second motor processor 206 can include a second vehicle motion control module. The use of two motor processors is for illustrative purposes only. In embodiments in which an electric vehicle includes more than two motors, the control system 200 can include more than two motor processors.

The vehicle motion control module 202 is responsive to various input, including a driver's request 208. The driver's request 208 can include a motion parameter such as velocity, acceleration, torque, braking, etc. The driver's request 208 can be entered at one or more human-machine interfaces, such as an acceleration pedal, a steering wheel, a brake pedal, etc. The vehicle motion control module 202 determines a torque to be applied at the vehicle based on the driver's request 208 and determines how to allocate torque to the motors of the vehicle in an optimal manner or in a manner that satisfies the driver's request. The vehicle motion control module 202 can also receive system constraints 210 indicating operating ranges of various components of the electric vehicle 100 and can use or consider the system constraints 210 when determining how to allocate the torques. For example, the vehicle motion control module 202 can perform an optimization program to determine the allocation of torque using the system constraints 210. In various embodiments, the system constraints 210 can include a desired acceleration profile for the vehicle during a gear shift operation.

Once torque allocation is determined, the vehicle motion control module 202 sends a torque command to each of the first motor processor 204 and the second motor processor 206. Each motor processor performs various operations and calculations to implement the torque. Also, the first motor processor 204 and the second motor processor 206 can communicate data or signals back to the vehicle motion control module 202.

Referring to the first motor processor 204 for illustrative purposes, the first motor processor receives a torque command from the vehicle motion control module 202 and determines an allocation of the torque command between the first motor 220 (e.g., rear motor 116) and the first transmission 222 (e.g., rear transmission 118). The first transmission 222 includes a transmission control module (TCM 224) which monitors the state of the first transmission, including an estimate of current axle torque, a current gear state or gear ratio, and an indicator of whether the transmission is current shifting gears (i.e., current shift operation is in progress).

The first motor processor 204 receives a torque command 212 from the vehicle motion control module 202 and a transmission control module request (TCM request 214) from the TCM 224. Based on this information, the first motor processor 204 performs torque arbitration 216 in which it determines how to accommodate the torque command for the first motor 220 from the vehicle motion control module 202 and the TCM request 214 from the first transmission 222 (i.e., from the TCM 224). The first motor processor 204 then performs motor control 218 to operate the first motor 220 using the torque that has been allocated to it via torque arbitration.

In various embodiments, the first motor processor 204 can determine a need for torque assistance based on its calculations and can send a torque request to the vehicle motion control module 202, as discussed herein. The vehicle motion control module 202 can be at either the main controller 132 or at the second motor processor 206. It is understood that the description of operation of the first motor processor 204 applies equally to the operation of the second motor processor 206.

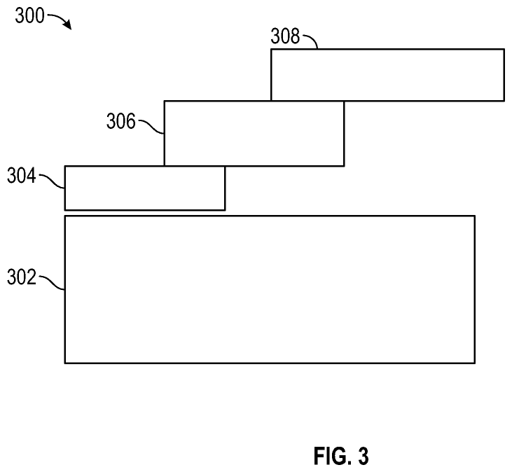

FIG. 3 shows a priority sequence 300 for torque arbitration through a single motor. The local processor (e.g., the first motor processor 204) will perform the operations in the order of priority shown. As an example, a first priority of the local processor is to satisfy the torque demand 302 from the supervisory control module (which includes torque demands based on driver's input). A second priority is to satisfy speed control operations 304. A third priority is to perform active damping operations 306. Active damping adjusts suspension stiffness in different driving situations, such as by making the ride smoother in normal driving situations or stiffening the suspension in high performance driving situations. A fourth priority is to fulfill a TMC request 308, such as by apportioning torque between the motor and components of the driveline and/or sending a request for torque assistance from other motors.

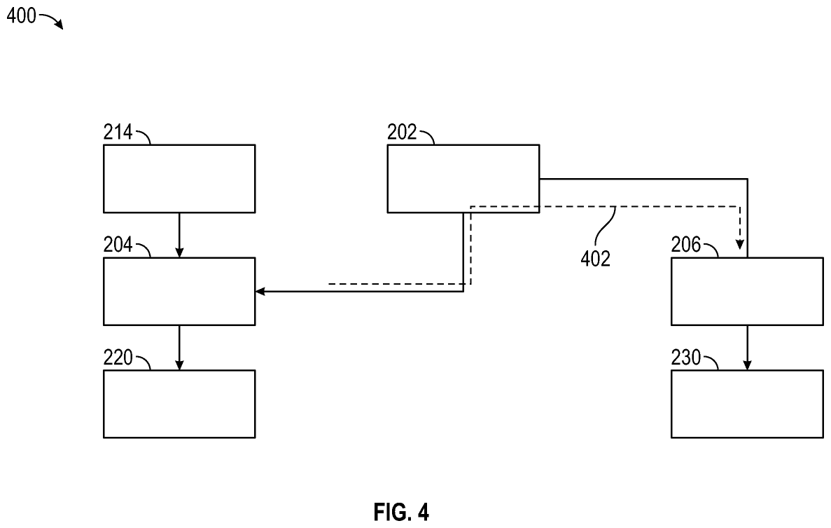

FIG. 4 schematically shows a feedback operation 400 in the control system 200. The first motor processor 204 receives a TCM torque request from the TCM 224 (FIG. 2). When possible, the first motor processor 204 performs the torque operation using only the first motor 220 (FIG. 2) to fulfill the TCM request. If the TCM request 214 cannot be fulfilled by the first motor, the first motor processor 204 sends a torque assistance request 402 to the vehicle motion control module 202 to request an adjustment (i.e., an increase or decrease) in an amount of torque being provided by the second motor 230. The first motor processor 204 can compute the amount of torque needed and send this amount to the vehicle motion control module 202 (which can be at the main controller 132 or at the second motor processor 206) in the torque assistance request 402.

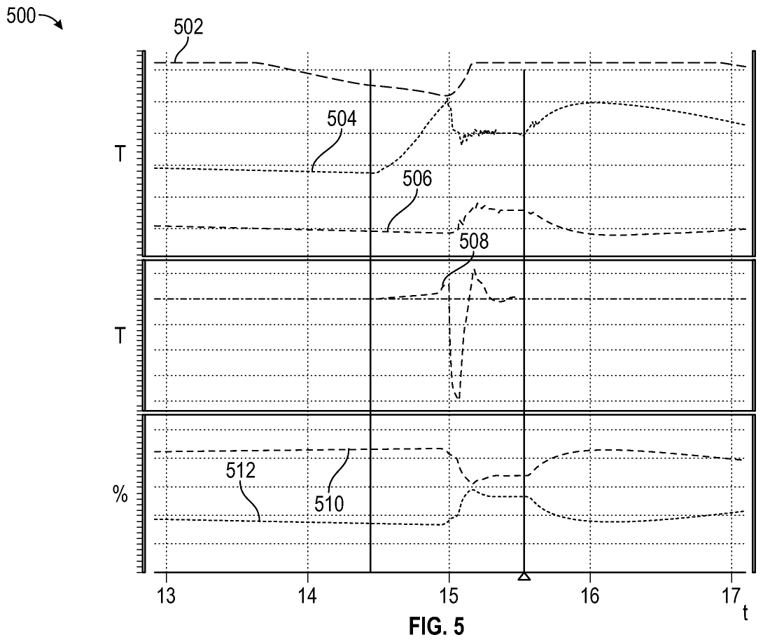

FIG. 5 shows a graph 500 of various parameters of the control system 200, in an illustrative embodiment. Time is shown along the abscissa. An upshift maneuver is initiated at about 14.45 seconds and is completed at about 15.5 seconds. The graph 500 includes a motor torque limit curve 502 for the first motor 220, a first motor torque curve 504 (for the first motor 220), a second motor torque curve 506 (for the second motor 230 (e.g., front motor 126)), a TCM request curve 508, a first axle torque curve 510 and a second axle torque curve 512.

As shown by the motor torque limit curve 502, the torque capacity of the first motor 220 decreases as the first motor torque curve 504 increases during the shift operation up until a TCM request is received (at about t=15 seconds). The TCM request coincides with a time at which the first motor torque curve 504 becomes greater than or equal to the motor torque limit curve 502. As the TCM request cannot be handled by the first motor 220, a torque assistance request is made that causes the second motor 230 to supply or increase a motor torque. Thus, at 15 seconds, the second motor torque curve 506 begins to increase in response to the torque assistance request. The first motor torque curve 504 decreases as the second motor torque curve 506 increases. The first axle torque curve 510 and the second axle torque curve 512 are shown as percentages of total torque and show the show the relative allocations of torques between the motors based on the TCM request.

The terms “a” and “an” do not denote a limitation of quantity, but rather denote the presence of at least one of the referenced item. The term “or” means “and/or” unless clearly indicated otherwise by context. Reference throughout the specification to “an aspect”, means that a particular element (e.g., feature, structure, step, or characteristic) described in connection with the aspect is included in at least one aspect described herein, and may or may not be present in other aspects. In addition, it is to be understood that the described elements may be combined in any suitable manner in the various aspects.

When an element such as a layer, film, region, or substrate is referred to as being “on” another element, it can be directly on the other element or intervening elements may also be present. In contrast, when an element is referred to as being “directly on” another element, there are no intervening elements present.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this disclosure belongs.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof.

What is claimed is:

1. A method of operating a vehicle, comprising:
receiving a torque command from a vehicle motion control module at a first motor processor associated with a first motor of the vehicle;
coordinating, at the first motor processor, an allocation of the torque command into a first motor torque at the first motor and a transmission torque at a first transmission associated with the first motor; and
controlling the first motor to apply the first motor torque at the first motor.

2. The method of claim 1, further comprising receiving a transmission control module request from the first transmission and controlling the first motor to fulfill the transmission control module request.

3. The method of claim 2, further comprising receiving, at the first motor processor, at least one of the transmission control module request, a current gear state, and a current shift operation of the first transmission.

4. The method of claim 1, further comprising determining, at the first motor processor, an amount of torque assistance from a second motor and sending a torque assistance request to a second motor processor associated with the second motor.

5. The method of claim 4, further comprising wherein the second motor processor adjusts a second torque at the second motor in response to receipt of the torque assistance request.

6. The method of claim 4, further comprising sending the torque assistance request when at least one of: (i) the first motor is unable to fulfill a transmission control module request; and (ii) the first torque at the first motor is equal to or greater than a torque limit for the first motor.

7. The method of claim 1, further comprising controlling the first motor to apply the first motor torque to fulfill one of a driver's request, a speed control, an active damping at the vehicle, and a transmission control module request.

8. A control system for operating a vehicle, comprising:
a first motor processor associated with a first motor of the vehicle, the first motor processor configured to:
determine a torque command;
coordinate an allocation of the torque command into a first motor torque at the first motor and a transmission torque at a first transmission associated with the first motor; and
control the first motor to apply the torque command at the first motor.

9. The control system of claim 8, further comprising a transmission control module at the first transmission, wherein the first motor processor is further configured to receive a transmission control module request from the transmission control module and control the first motor to fulfill the transmission control module request.

10. The control system of claim 9, wherein the first motor processor is further configured to receive at least one of the transmission control module request, a current gear state, and a current shift operation of the first transmission.

11. The control system of claim 8, further comprising a second motor processor at a second motor of the vehicle, wherein the first motor processor is further configured to determine an amount of torque assistance from the second motor and sending a torque assistance request to the second motor processor associated with the second motor.

12. The control system of claim 11, wherein the second motor processor is configured to adjust a second torque at the second motor in response to receipt of the torque assistance request.

13. The control system of claim 11, wherein the first motor processor is further configured to send the torque assistance request when at least one of: (i) the first motor is unable to fulfill a transmission control module request; and (ii) the first torque at the first motor is equal to or greater than a torque limit for the first motor.

14. The control system of claim 8, wherein the first motor processor is further configured apply the first motor torque to fulfill at least one of: a driver's request, a speed control, active damping at the vehicle, and a transmission control module request.

15. A vehicle, comprising:
a first motor processor associated with a first motor of the vehicle, the first motor processor configured to:
determine a torque command;
coordinate an allocation of the torque command into a motor torque at the first motor and a transmission torque at a first transmission associated with the first motor; and
control the first motor to apply the torque command at the first motor.

16. The vehicle of claim 15, further comprising a transmission control module associated with the first transmission, wherein the first motor processor is further configured to receive a transmission control module request from the transmission control module and to control the first motor to fulfill the transmission control module request.

17. The vehicle of claim 16, wherein the first motor processor is further configured to receive at least one of the transmission control module request, and a current gear state, a current shift operation of the first transmission.

18. The vehicle of claim 15, further comprising a second motor processor at a second motor, wherein the first motor processor is further configured to determine an amount of torque assistance from the second motor and send a torque assistance request to the second motor processor associated with the second motor.

19. The vehicle of claim 18, wherein the second motor processor is configured to adjust a second torque at the second motor in response to receipt of the torque assistance request.

20. The vehicle of claim 18, wherein the first motor processor is further configured to send the torque assistance request when at least one of: (i) the first motor is unable to fulfill a transmission control module request; and (ii) the first torque at the first motor is equal to or greater than a torque limit for the first motor.
